(19) United States
(12) Patent Application Publication
(10) Pub. No.: US 2026/0258308 A1
(43) Pub. Date: Sep. 3, 2026

(54) AROMATIC AND POLAR COMPOUNDS REMOVAL IN LUBE FEEDSTOCKS BY COUNTER CURRENT LIQUID-LIQUID EXTRACTION USING DIHYDROLEVOGLUCOSENONE AS A SOLVENT

(71) Applicant: ExxonMobil Technology and Engineering Company, Spring, TX (US)

(72) Inventors: Toufic Aridi, Sarnia (CA); Darden Steve Sinclair, Spring, TX (US); Gaither M. Phillips, Spring, TX (US); Christopher J. Wheeler, Sarnia (CA)

(73) Assignee: ExxonMobil Technology and Engineering Company, Spring, TX (US)

(21) Appl. No.: 19/163,273

(22) PCT Filed: Feb. 20, 2024
(86) PCT No.: PCT/US2024/016512

§ 371 Date: Sep. 8, 2025

Related U.S. Application Data
(60) Provisional application No. 63/456,858, filed on Apr. 4, 2023.

(51) Int. Cl. C10G 55/04; B01D 11/04

(52) U.S. Cl. CPC C10G 55/04; B01D 11/0492; C10G 2300/1059; C10G 2400/10

(57) ABSTRACT

A method may include: introducing a stream comprising a vacuum gas oil into a liquid-liquid extraction unit; contacting the vacuum gas oil with a dihydrolevoglucosenone solvent to extract a portion of aromatic compounds from the vacuum gas oil to produce a raffinate stream with reduced aromatic compound concentration; and dewaxing the raffinate stream to form a base stock.

### CROSS-REFERENCE TO RELATED APPLICATIONS

This application is a national stage application, filed under 35 U.S.C. 371, of International Patent Application No. PCT/US2024/016512, filed Feb. 20, 2024, which claims the priority of U.S. Provisional Patent Application No. 63/456,858, filed Apr. 4, 2023, which is incorporated by reference in its entirety.

### FIELD

This disclosure relates to lubricant base stocks produced using a liquid-liquid extraction process utilizing dihydrolevoglucosenone as a solvent, blends of the base stocks, formulated lubricant compositions containing the base stocks, and uses of the base stocks.

### BACKGROUND

Base stock is the major constituent in finished lubricants and contributes significantly to their properties. For example, engine oils are finished crankcase lubricants intended for use in automobile engines and diesel engines and contain two general components, namely, a base stock (one base stock or a blend of base stocks) and additives. In general, a few lubricating base stocks are used to manufacture a variety of engine oils by varying the mixtures of individual lubricating base stocks and individual additives. Base stocks are also used for other purposes such as processing oils for manufacturing various articles such as tires.

According to the American Petroleum Institute (API) classifications, base stocks are categorized in five groups based on their saturated hydrocarbon content, sulfur level, and viscosity index (Table 1). Lube base stocks are typically produced in large scale from non-renewable petroleum sources. Group I, II, and III base stocks are all derived from crude oil via extensive processing, such as solvent extraction, solvent or catalytic dewaxing, and hydroisomerization. Group III base stocks can also be produced from synthetic hydrocarbon liquids obtained from natural gas, coal or other fossil resources, Group IV base stocks are polyalphaolefins (PAOs), and are produced by oligomerization of alpha olefins, such as 1-decene. Group V base stocks include all base stocks that do not belong to Groups I-IV, such as naphthenics, polyalkylene glycols (PAG), and esters.

TABLE 1

| API | Group | Group | Group | Group | Group |
|---|---|---|---|---|---|
| classification | I | II | III | IV | V |
| % Saturates | <90 | ≥90 | ≥90 | Polyalphaolefins | All others |
| % Sulfur | >0.03 | ≤0.03 | ≤0.03 | (PAOs) | not |
| Viscosity | 80-120 | 80-120 | 120 | | belonging |
| Index (VI) | | | | | to group I- |
| | | | | | IV |

Base stocks are generally produced from the higher boiling fractions recovered from a petroleum derived feedstock via distillation operation. Base stocks may be prepared from either petroleum-derived feedstocks or from synthesis of lower molecular weight molecules. Often the feeds to lubricant production contains aromatic compounds which need to be removed. Liquid-liquid extraction methods using an aromatic selective solvent may be utilized to remove aromatics to an acceptable level. The aromatic selective solvents are typically aprotic dipolar solvents such as phenol, furfural, n-methyl pyrrolidone (NMP). These solvents can be combined with water to provide a solvent mixture containing up to about 10 vol. % water. The hydrocarbon stream and the selective solvent or solvent mixture are combined, typically and preferably under counter-current conditions. The contacting results in concentration of the aromatic component in the selective solvent. Because the solvent and the hydrocarbon oil are of different densities and generally immiscible, after the contacting the aromatics rich solvent phase separates from the mixture thereby resulting in an aromatics rich solvent phase called the extract and an aromatics lean non-aromatics rich product phase called the raffinate. Liquid-liquid extraction of lube feedstocks removes aromatic and polar compounds so as to meet the required viscosity index (VI) and saturates content on the finished basestock. The secondary effects are refractive index (RI) reduction, density reduction, viscosity reduction, Condrason Carbon Residue (CCR) reduction, and color improvement. However, the use of solvents such as n-methyl pyrrolidone (NMP), furfural, and phenol have certain risks that must be managed including safety, toxicity, and aquatic toxicity. In particular, NMP is increasingly under pressure and regulatory restriction to minimize its use in industry.

### SUMMARY

Disclosed herein is an example method including: introducing a stream comprising a vacuum gas oil into a liquid-liquid extraction unit; contacting the vacuum gas oil with a dihydrolevoglucosenone solvent to extract a portion of aromatic compounds from the vacuum gas oil to produce a raffinate stream with reduced aromatic compound concentration; and dewaxing the raffinate stream to form a base stock.

Further disclosed herein is a method including: thermally cracking a hydrocarbon feedstock to produce a cracked product stream; separating at least a portion of the cracked product stream to form a lubricant boiling range fraction of the cracked product stream; deasphalting at least a portion of the lubricant boiling range fraction to form a deasphalted oil; introducing the deasphalted oil into a liquid-liquid extraction unit; contacting the deasphalted oil with a dihydrolevoglucosenone solvent to extract a portion of aromatic compounds from the deasphalted oil to produce a raffinate stream with reduced aromatic compound concentration; and dewaxing the raffinate stream to form a base stock.

These and other features and attributes of the disclosed base stocks produced using a liquid-liquid extraction process utilizing dihydrolevoglucosenone as a solvent, blends of base stocks, formulated lubricant compositions containing the base stocks, and uses of base stocks of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is a block flow diagram of a process to produce base stocks in accordance with some embodiments of the present disclosure.

FIG. 2 is a graph of experimental data of treatment rate versus raffinate refractive index in accordance with some embodiments of the present disclosure.

FIG. 3 is a graph of experimental data of treatment rate versus raffinate yield in accordance with some embodiments of the present disclosure.

FIG. 4 is a graph of experimental data of treatment rate versus dewaxed oil kinematic viscosity at 40° C. in accordance with some embodiments of the present disclosure.

FIG. 5 is a graph of experimental data of treatment rate versus dewaxed oil viscosity index in accordance with some embodiments of the present disclosure.

FIG. 6 is a graph of experimental data of treatment rate versus dewaxed oil total aromatics in accordance with some embodiments of the present disclosure.

FIG. 7 is a graph of experimental data of dewaxed oil total aromatics at constant treatment rate in accordance with some embodiments of the present disclosure.

FIG. 8 is a graph of experimental data of dewaxed oil total 2+ aromatics at constant treatment rate in accordance with some embodiments of the present disclosure.

FIG. 9 is a graph of experimental data of dewaxed oil total 3+ aromatics at constant treatment rate in accordance with some embodiments of the present disclosure.

FIG. 10 is a graph of experimental data of dewaxed oil sulfur content at constant treatment rate in accordance with some embodiments of the present disclosure.

FIG. 11 is a graph of experimental data of dewaxed oil basic nitrogen content at constant treatment rate in accordance with some embodiments of the present disclosure.

FIG. 12 is a graph of experimental data of dewaxed oil viscosity index versus total aromatics in accordance with some embodiments of the present disclosure.

FIG. 13 is a graph of experimental data of dewaxed oil viscosity index versus 2+ aromatics in accordance with some embodiments of the present disclosure.

FIG. 14 is a graph of experimental data of dewaxed oil viscosity index versus 3+ aromatics in accordance with some embodiments of the present disclosure.

FIG. 15 is a graph of experimental data of dewaxed oil viscosity index versus total sulfur in accordance with some embodiments of the present disclosure.

FIG. 16 is a graph of experimental data of dewaxed oil viscosity index versus total basic nitrogen in accordance with some embodiments of the present disclosure.

FIG. 17 is a graph of experimental data of dewaxed oil treatment rate versus raffinate yield for NMP and dihydrolevoglucosenone in accordance with some embodiments of the present disclosure.

FIG. 18 is a graph of experimental data of dewaxed oil treatment rate versus kinematic viscosity at 40° C. for NMP and dihydrolevoglucosenone in accordance with some embodiments of the present disclosure.

### DETAILED DESCRIPTION

Disclosed herein are methods of producing lubricant base stocks using a process comprising liquid-liquid extraction (LLE) of a lubricant feedstock to remove aromatic compounds from the lubricant feedstock followed by solvent dewaxing and fractionation to produce a Group I base stock. In embodiments, the liquid-liquid extraction step utilizes dihydrolevoglucosenone as a solvent.

The methods disclosed herein have several advantages over previously used solvents in liquid-liquid extraction of lubricant feedstocks, only some of which may be alluded to herein. One of the advantages of dihydrolevoglucosenone is that it is a biologically derived solvent which can be synthesized from lignocellulosic biomass. Dihydrolevoglucosenone is also less toxic than other aprotic dipolar solvents currently used for liquid-liquid extraction of lubricant feedstock. Dihydrolevoglucosenone also has ideal physical properties for LLE including selectivity to aromatic compounds to effectively removes the aromatic compounds, has excellent thermal stability, and boils readily to facilitate recycle. As will be shown in the examples below, dihydrolevoglucosenone does not have significant yield loss versus conventional LLE solvents used in base stock production. Dihydrolevoglucosenone is also considered safe for end of life disposal as it decomposes into carbon dioxide and water.

### Process for Producing Base Stock

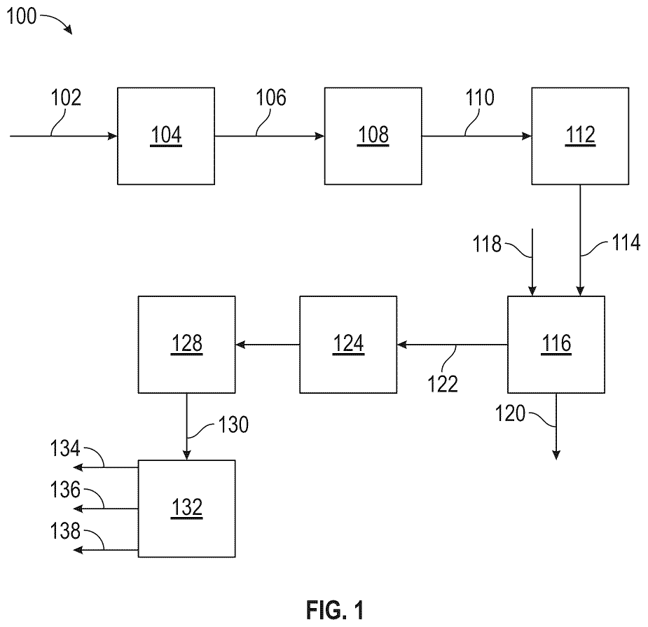

FIG. 1 is a block flow diagram of a process 100 to produce base stocks in accordance with some embodiments of the present disclosure. Process 100 begins with introducing hydrocarbon feedstock 102 into thermal cracking unit 104. Hydrocarbon feedstock may include hydrocarbons such as hydrocarbons with a boiling greater than 300° F. (149° C.) or a portion of a crude oil with a boiling greater than 300° F. (149° C.) or any other suitable feedstock. In thermal cracking unit 104, at least a portion of the hydrocarbons in hydrocarbon feedstock 102 are cracked to form a cracked product stream 106. Note that thermal cracking is an optional step. The cracked product stream 106 or hydrocarbon feedstock 102 may be introduced into distillation unit 108 where a lower boiling point fraction of the cracked products, such as fuel range hydrocarbons, are separated from a lubricant boiling point fraction of the cracked products. Distillation unit 108 may be operated at any suitable cut point such as in a range of 650° F. (343° C.) to 800° F. (427° C.). Alternatively, in a range of 650° F. (343° C.) to 700° F. (370° C.), 700° F. (370° C.) to 750° F. (399° C.), 750° F. (399° C.) to 800° F. (427° C.), or any ranges therebetween.

From distillation unit 108, stream 110 containing the lubricant boiling point fraction of the cracked products is introduced into deasphalting unit 112. In deasphalting unit 112, asphaltenes are removed from the lubricant boiling point fraction of the cracked products to form deasphalted oil stream 114. Note that deasphalting is an optional step of processing. Deasphalted oil stream 114 or stream 110 is introduced into liquid-liquid extraction unit 116 along with dihydrolevoglucosenone solvent stream 118. The deasphalted oil or stream 110 and dihydrolevoglucosenone are contacted in liquid-liquid extraction unit 116 to at least partially extract aromatics present in the deasphalted oil or stream 110 into the dihydrolevoglucosenone to form an aromatics rich dihydrolevoglucosenone extract stream 120 and a lean raffinate stream 122. The lean raffinate stream 122 may be optionally fed to hydrotreatment unit 124 to be hydrotreated before being introduced into dewaxing unit 128. In hydrotreatment, the raffinate stream is reacted with hydrogen in the presence of a catalyst at pressure and temperature conditions sufficient to at least partially convert undesirable aromatics and olefins into more stabilized products and to remove heteroatoms to improve color and oxidation stability of the final basestock. Dewaxed effluent 130 may be introduced into distillation unit 132 to form one or more base stock fractions such as light neutral base stock 134, heavy neutral base stock 136, and brightstock 138. If dewaxing unit 128 corresponds to a catalytic dewaxing process, the resulting base stock can be Group II or Group III base stocks. If dewaxing unit 128 corresponds to a solvent dewaxing process, the resulting base stocks can be Group I or Group II base stocks. The various steps of the process of making basestocks may be used in different sequences and some could be omitted depending on processing needs for a given feedstock.

### Feedstocks

Hydrocarbon feedstocks suitable for produce base stocks may include, but are not limited to, bitumens and residuum from refinery distillation processes, including atmospheric and vacuum distillation processes. Such hydrocarbons can have an initial boiling point (such as an initial ASTM D2892 boiling point) of 300° F.+(149° C.) or greater. In embodiments, the hydrocarbons can have a 10% distillation point (such as an ASTM D2892 10% distillation point) of at least 650° F. (343° C.), alternatively at least 660° F. (349° C.) or at least 750° F. (399° C.). In some embodiments the 10% distillation point can be still greater, such as at least 900° F. (482° C.), or at least 950° F. (510° C.), or at least 975° F. (524° C.), or at least 1020° F. (549° C.) or at least 1050° F. (566° C.).

### Thermal Cracking

In embodiments, the hydrocarbon feedstock is thermally cracked to generate lower molecular weight hydrocarbons. The thermal cracking can be performed by any method that allows for suitable amounts of conversion, such as by fluidized coking, optionally but preferably operated in a once-through configuration, optionally but more preferably operated in a deep recycle cutpoint configuration, or by hydroconversion. In fluidized bed coking, normal operation uses a 975° F. (524° C.) recycle cutpoint and produces a heavy coker gasoil with 5-10 wt. % of an unconverted 1050° F.+(566° C.) portion. Deep recycle cutpoint operation increases the recycle cutpoint to 1000° F. (538° C.) or greater, and produces a heavy coker gasoil with 10-15 wt. % of a 1050° F.+(566° C.) portion. By performing a limited amount of single pass conversion of the 1050° F.+(566° C.) portion of the feed, an increased number of compounds can be formed and/or retained within the thermally cracked feed that can contribute to lubricant base stocks that have high viscosity as well as high viscosity index.

In embodiments, the thermal cracking can be a coking process. Coking can be used to process a hydrocarbon feedstock as part of a process for forming base stock. An example of a suitable configuration for coking is fluidized coking. Instead of operating the coking process in a conventional manner (delayed coking) to achieve nearly complete conversion of the 1050° F.+(566° C.+) portion of a hydrocarbon feedstock, the coking process can be operated to achieve about 30 wt. % to about 80 wt. % conversion of the 1050° F.+(566° C.+) portion of the hydrocarbon feedstock. It is noted that other types of coking could be used for thermal cracking if the coking method is suitable for operation at reduced levels of conversion of the 1050° F.+(566° C.+) portion of the feed, such as delayed coking operated at some combination of lower pressure and higher temperature, or a visbreaking process. Delayed coking can be effectively operated at lower pressure by recycling 1050° F. (566° C.+) product fractions to the coke drum to strip out some of the 1050° F.+(566° C.+) fraction. However, such modification of the conversion percentage for the 1050° F.+(566° C.+) portion of a feed may prove difficult for some types of coking configurations, such as typical configurations for delayed coking.

Fluidized coking is carried out at temperatures from about 900° F. (482° C.) to about 1100° F. (593° C.). Conventional fluid coking is performed in a process unit comprised of a coking reactor and a heater or burner. A hydrocarbon feedstock is injected into the reactor in a coking zone comprised of a fluidized bed of hot, fine, coke particles and is distributed relatively uniformly over the surfaces of the coke particles where it is cracked to vapors and coke. The vapors pass through a gas/solids separation apparatus, such as a scrubber, where contact with 1050° F.+(566° C.+) liquid feedstock and/or heavy product recycle removes most of the entrained coke particles and cools the vapors to condense the heavy liquid products. In a conventional fluidized coking apparatus, the resulting slurry of hydrocarbon feedstock, condensed heavy liquid product, and coke particles, which usually contains from about 1 wt. % to about 3 wt. % coke particles, is recycled to extinction to the coking zone. However, in various aspects of the disclosure, only a portion of the slurry is recycled and/or the slurry may not be recycled (once-through operation). The balance of the vapors go to a fractionator for separation of the gases and the liquids into different boiling fractions.

Hydroconversion processes can also be used to thermally crack a hydrocarbon feedstock for production of base stock. The relative amount of hydroconversion versus the amount of thermal cracking can be controlled based on the hydroconversion conditions. In various aspects, the hydroconversion conditions can be selected to have relatively low partial pressures of hydrogen, such as about 400 psig (2.7 MPa) to about 1500 psig (10.3 Mpa) of hydrogen, for example about 1250 psig (8.6 Mpa) or less, or about 1000 psig (6.9 Mpa) or less. The relatively low partial pressure of hydrogen can be used with temperatures of at least about 400° C., for example at least about 425° C., to provide hydroconversion conditions where a substantial portion of the reactions correspond to thermal cracking reactions. A hydrogen stream can be fed or injected into a vessel or reaction zone or hydroprocessing zone in which the hydroprocessing catalyst is located. Hydrogen, which is contained in a hydrogen “treat gas,” is provided to the reaction zone. Treat gas, as referred to herein, can be either pure hydrogen or a hydrogen-containing gas, which is a gas stream containing hydrogen in an amount that is sufficient for the intended reaction(s), optionally including one or more other gasses (e.g., nitrogen and light hydrocarbons such as methane), and which will not adversely interfere with or affect either the reactions or the products. The treat gas stream introduced into a reaction stage will typically contain at least about 50 vol. % and more preferably at least about 75 vol. % hydrogen. The temperature in the contacting zone can be at least about 732° F. (390° C.) or at least about 788° F. (420° C.). Additionally, or alternately, the temperature in the contacting zone can be about 950° F. (510° C.) or less, such as about 900° F. (482° C.) or less, and preferably about 850° F. (454° C.) or less or about 800° F. (427° C.) or less. Total pressure in the contacting (hydroprocessing) zone can range from 200 psig (1379 kPa-g) to 3000 psig (20684 kPa-g), such as from 400 psig (2758 kPa-g) to 2000 psig (13790 kPa-g), or from 650 psig (4482 kPa-g) to 1500 psig (10342 kPa-g), or from 650 psig (4482 kPa-g) to 1200 psig (8273 kPa-g). A hydrocarbon feedstock can be hydroprocessed under low hydrogen partial pressure conditions. In such aspects, the hydrogen partial pressure during hydroprocessing can be from about 200 psig (1379 kPa-g) to about 1000 psig (6895 kPa-g), such as from 500 psig (3447 kPa-g) to about 800 psig (5516 kPa-g). Additionally, or alternately, the hydrogen partial pressure can be at least about 200 psig (1379 kPa-g), or at least about 400 psig (2758 kPa-g), or at least about 600 psig (4137 kPa-g). Additionally, or alternately, the hydrogen partial pressure can be about 1000 psig (6895 kPa-g) or less, such as about 900 psig (6205 kPa-g) or less, or about 850 psig (5861 kPa-g) or less, or about 800 psig (5516 kPa-g) or less, or about 750 psig (5171 kPa-g) or less. In such aspects with low hydrogen partial pressure, the total pressure in the reactor can be about 1200 psig (8274 kPa-g) or less, and preferably 1000 psig (6895 kPa-g) or less, such as about 900 psig (6205 kPa-g) or less or about 800 psig (5516 kPa-g) or less.

### Fractionating

Thermally cracking the hydrocarbon feed, the resulting products can be exposed to a series of additional processing steps to form products, including lubricant base stocks. As an initial procedure, the products from the thermal cracking process can be fractionated or otherwise separated to separate lower boiling portions (such as naphtha and diesel boiling range compounds) from one or more portions having a boiling range suitable for forming lubricant base stocks (a lubricant boiling range fraction). For example, a fractionation or other separation can be used to separate from the thermal cracking effluent one or more portions having a 10% distillation point of at least about 650° F. (343° C.), or at least about 700° F. (371° C.), or at least about 750° F. (399° C.), or at least about 800° F. (427° C.). Additionally or alternately, the thermal cracking effluent can be separated to form one or more portions having an initial boiling point of at least about 650° F. (343° C.), or at least about 700° F. (371° C.), or at least about 750° F. (399° C.), or at least about 800° F. (427° C.).

### Dewaxing

After fractionation, the lower boiling portion may be exposed to solvent dewaxing. Typical solvents include alkanes or other hydrocarbons containing about 3 to about 6 carbons per molecule. Examples of suitable solvents include propane, n-butane, isobutane, and n-pentane. Alternatively, other types of solvents may also be suitable, such as supercritical fluids. During solvent deasphalting, a feed portion is mixed with the solvent. Portions of the feed that are soluble in the solvent are then extracted, leaving behind a residue with little or no solubility in the solvent. Typical solvent deasphalting conditions include mixing a feedstock fraction with a solvent in a weight ratio of from about 1:2 to about 1:10, such as about 1:8 or less. Typical solvent deasphalting temperatures range from about 40° C. to about 150° C. Alternatively, in a range of 40° C. to 80° C., 80° C. to 120° C., 120° C. to 150° C., or any ranges therebetween. The pressure during solvent deasphalting can be from about 350 kPag to about 3500 kPag. Alternatively, from 3500 kPag to about 1000 kPag, 1000 kPag to about 2000 kPag, 2000 kPag to about 3500 kPag, or any ranges therebetween.

The portion of the deasphalted feedstock that is extracted with the solvent is often referred to as deasphalted oil. In some embodiments, a bottoms from vacuum distillation can be used as the feed to the solvent deasphalter, so the portion extracted with the solvent can also be referred to as deasphalted bottoms. The yield of deasphalted oil from a solvent deasphalting process varies depending on a variety of factors, including the nature of the feedstock, the type of solvent, and the solvent extraction conditions. A lighter molecular weight solvent such as propane will result in a lower yield of deasphalted oil as compared to n-pentane, as fewer components of a bottoms fraction will be soluble in the shorter chain alkane. However, the deasphalted oil resulting from propane deasphalting is typically of higher quality, resulting in expanded options for use of the deasphalted oil. Under typical deasphalting conditions, increasing the temperature will also usually reduce the yield while increasing the quality of the resulting deasphalted oil. In various embodiments, the yield of deasphalted oil from solvent deasphalting can be about 85 wt. % or less of the feed to the deasphalting process, or about 75 wt. % or less. In embodiments, the solvent deasphalting conditions are selected so that the yield of deasphalted oil is at least about 65 wt. %, such as at least about 70 wt. % or at least about 75 wt. %.

### Liquid-Liquid Extraction

The deasphalted oil can be subjected to liquid-liquid extraction to reduce the aromatics content and/or the amount of polar molecules. The liquid-liquid extraction process selectively dissolves aromatic components to form an aromatics-rich extract phase while leaving the more paraffinic components in an aromatics-poor raffinate phase. Naphthenes are distributed between the extract and raffinate phases. Typical solvents for liquid-liquid extraction include phenol, furfural, and N-methyl pyrrolidone. As discussed above, these solvents are hydrocarbon sourced and toxic. Dihydrolevoglucosenone is used in place of or to replace a portion of the solvent used in liquid-liquid extraction.

In embodiments, the liquid-liquid extraction process utilizes a counter-current liquid-liquid extractor. Depending on the initial concentration of aromatics in the deasphalted oil and operating conditions of the liquid-liquid extraction process, the raffinate phase can have an aromatics content in a range of about 0.5 wt. % to about 25 wt. %. Alternatively, from 0.5 wt. % to about 5 wt. %., 5 wt. % to about 15 wt. %., 15 wt. % to about 25 wt. %., or any ranges therebetween. In embodiments, the liquid-liquid extraction process can be operated at any suitable temperatures for the feed dewaxed oil and feed solvent. For example, the dewaxed oil and solvent may have a temperature in a range of 50° C. to 150° C. Alternatively, in a range of 50° C. to 75° C., 75° C. to 100° C., 100° C. to 150° C., or any ranges therebetween. The liquid-liquid extraction process can be operated such that the feed dewaxed oil and solvent temperature are at least 1° C. apart, at least 5° C. apart, at least 10° C. apart, at least 15° C. apart, at least 20° C. apart, at least 25° C. apart, at least 30° C. apart, or any degree therebetween. In embodiments, the liquid-liquid extraction process can be operated such that the feed dewaxed oil and solvent temperature are at least about 10° C. to about 20° C. apart, at least about 10° C. to about 25° C. apart, or at least about 10° C. to about 30° C. apart. The liquid-liquid extraction process can be operated such that the feed dewaxed oil and solvent temperature have a temperature difference in a range of 1° C. to 50° C. The treatment volume of dihydrolevoglucosenone solvent may be provided in an amount of about 50 vol. % to 300 vol. % by volume of dewaxed oil. Alternatively, from 50 vol. % to 100 vol. %, from 100 vol. % to 150 vol. %, from 150 vol. % to 200 vol. %, from 200 vol. % to 250 vol. %, from 250 vol. % to 300 vol. %, or any ranges therebetween. In some embodiments, the dihydrolevoglucosenone solvent may contain dihydrolevoglucosenone and water. In embodiments, the water may be present in an amount of 0.1 vol. % to 10 vol. % in the dihydrolevoglucosenone solvent. Alternatively, from 0.1 vol. % to 1 vol. %, 1 vol. % to 3 vol. %, 3 vol. % to 7 vol. %, 7 vol. % to 10 vol. %, or any ranges therebetween.

In some embodiments, the deasphalted oil and the optionally additional vacuum gas oil boiling range fractions or other additional fractions can be solvent processed together. An example of a suitable type of gas oil fraction is a wide cut vacuum gas oil (VGO), with a T5 boiling point of at least about 700° F. (371° C.) and a T95 boiling point of about 1100° F. or less, preferably a T95 boiling point of about 1000° F. (538° C.) or less. Alternatively, the deasphalted bottoms and the additional vacuum gas oil boiling range fractions can be solvent processed separately, to facilitate formation of different types of base stock. More generally, any convenient number of fractions can be formed from the deasphalted oil and/or additional higher boiling fractions to allow for separate solvent processing if desired.

The raffinate from the solvent extraction may be under-extracted. In under-extraction, the extraction is carried out under conditions such that the raffinate yield is maximized while still removing most of the lowest quality molecules from the feed. Raffinate yield may be maximized by controlling extraction conditions, for example, by lowering the solvent to oil treat ratio and/or decreasing the extraction temperature. In some embodiments, the raffinate yield from solvent extraction can be at least about 25 wt. % to about 100 wt. %. Alternatively, from 25 wt. % to 50 wt. %, 50 wt. % to 75 wt. %, 75 wt. % to 100 wt. %, or any ranges therebetween.

In embodiments, the deasphalted oil, the raffinate from solvent extraction of the deasphalted oil, and/or the hydrocracked deasphalted oil can have a combination of viscosity index and viscosity at 100° C. For example, the deasphalted oil, the raffinate from solvent extraction of the deasphalted oil, and/or the hydrocracked deasphalted oil can have a viscosity index of at least about 50, or at least about 60, or at least about 70, or at least about 75, or at least about 80, or at least about 85, or at least about 90, such as up to about 120 or more. In such aspects, the deasphalted oil, the raffinate from solvent extraction of the deasphalted oil, and/or the hydrocracked deasphalted oil can have such a viscosity index in combination with having a viscosity at 100° C. of at least about 7.0 cSt, or at least about 7.5 cSt, or at least about 8.0 cSt, or at least about 8.5 cSt, or at least about 9.0 cSt, such as up to about 25 cSt or more.

### Hydrotreatment

In some embodiments, after deasphalting and optional solvent extraction, the deasphalted oil and any additional fractions combined with the deasphalted oil can further undergo hydrotreatment processing to remove heteroatoms to desired levels. Hydrotreatment may include hydrocracking and/or hydrofinishing. The hydrotreatment is carried out in the presence of hydrogen. A hydrogen stream is, therefore, fed or injected into a vessel or reaction zone or hydroprocessing zone in which the hydroprocessing catalyst is located. Hydrogen, which is contained in a hydrogen “treat gas,” is provided to the reaction zone. Treat gas, can be either pure hydrogen or a hydrogen-containing gas, which is a gas stream containing hydrogen in an amount that is sufficient for the intended reaction(s), optionally including one or more other gasses (e.g., nitrogen and light hydrocarbons such as methane), and which will not adversely interfere with or affect either the reactions or the products. Impurities, such as HS and NH₃ are undesirable and would typically be removed from the treat gas before it is conducted to the reactor. The treat gas stream introduced into a reaction stage may contain at least about 50 vol. % and more preferably at least about 75 vol. % hydrogen. Hydrotreating conditions can include temperatures of 200° C. to 450° C., or 315° C. to 425° C.; pressures of 250 psig (1.8 MPag) to 5000 psig (34.6 MPag) or 300 psig (2.1 MPag) to 3000 psig (20.8 MPag); liquid hourly space velocities (LHSV) of 0.1 hr⁻¹ to 10 hr⁻¹; and hydrogen treat rates of 200 scf/B (35.6 m³/m³) to 10,000 scf/B (1781 m³/m³), or 500 (89 m³/m³) to 10,000 scf/B (1781 m³/m³). In order to achieve a desired level of conversion, a reaction system can include at least one hydrocracking catalyst. Hydrocracking catalysts typically contain sulfided base metals on acidic supports, such as amorphous silica alumina, cracking zeolites such as USY, or acidified alumina. Often these acidic supports are mixed or bound with other metal oxides such as alumina, titania, or silica. Examples of suitable acidic supports include acidic molecular sieves, such as zeolites or silicoaluminophosphates. One example of suitable zeolite is USY, such as a USY zeolite with cell size of 24.30 Angstroms or less. Additionally, or alternately, the catalyst can be a low acidity molecular sieve, such as a USY zeolite with a Si to Al ratio of at least about 20, and preferably at least about 40 or 50. ZSM-48, such as ZSM-48 with a SiO₂ to Al₂O₃ ratio of about 110 or less, such as about 90 or less, is another example of a potentially suitable hydrocracking catalyst. Still another option is to use a combination of USY and ZSM-48. Still other options include using one or more of zeolite Beta, ZSM-5, ZSM-35, or ZSM-23, either alone or in combination with a USY catalyst. Non-limiting examples of metals for hydrocracking catalysts include metals or combinations of metals that include at least one Group VIII metal, such as nickel, nickel-cobalt-molybdenum, cobalt-molybdenum, nickel-tungsten, nickel-molybdenum, and/or nickel-molybdenum-tungsten. Additionally, or alternately, hydrocracking catalysts with noble metals can also be used. Non-limiting examples of noble metal catalysts include those based on platinum and/or palladium. Support materials which may be used for both the noble and non-noble metal catalysts can comprise a refractory oxide material such as alumina, silica, alumina-silica, kieselguhr, diatomaceous earth, magnesia, zirconia, or combinations thereof, with alumina, silica, alumina-silica being the most common.

A hydrofinishing and/or aromatic saturation stage can also be provided. The hydrofinishing and/or aromatic saturation stage can occur after the last bed of any optional hydrotreating catalyst. The hydrofinishing and/or aromatic saturation can occur either before or after dewaxing. The hydrofinishing and/or aromatic saturation can occur either before or after fractionation. If hydrofinishing and/or aromatic saturation occurs after fractionation, the hydrofinishing can be performed on one or more portions of the fractionated product, such as being performed on the bottoms from a prior reaction stage (such as hydrocracker bottoms). Alternatively, the entire effluent from the last hydrocracking or dewaxing process can be hydrofinished and/or undergo aromatic saturation.

### Dewaxing

After any optional hydrotreatment, the deasphalted oil can be catalytically dewaxed or solvent dewaxed to produce one or more base stock fractions. Solvent dewaxing is more commonly used to form Group I base stocks. Catalytic dewaxing is more commonly used for production of Group H or Group III base stocks. It is noted that fractionation of the dewaxing effluent into lubricant base stock fractions is typically performed after dewaxing, but fractionation can alternatively be performed prior to dewaxing if desired.

For catalytic dewaxing, suitable dewaxing catalysts can include molecular sieves such as crystalline aluminosilicates (zeolites). In an embodiment, the molecular sieve can comprise, consist essentially of, or be ZSM-22, ZSM-23, ZSM-48. Optionally but preferably, molecular sieves that are selective for dewaxing by isomerization as opposed to cracking can be used, such as ZSM-48, ZSM-23, or a combination thereof. Additionally, or alternately, the molecular sieve can comprise, consist essentially of, or be a 10-member ring 1-D molecular sieve, such as EU-2, EU-11, ZBM-30, ZSM-48, or ZSM-23. ZSM-48 is most preferred. Note that a zeolite having the ZSM-23 structure with a silica to alumina ratio of from about 20:1 to about 40:1 can sometimes be referred to as SSZ-32. Optionally but preferably, the dewaxing catalyst can include a binder for the molecular sieve, such as alumina, titania, silica, silica-alumina, zirconia, or a combination thereof, for example alumina and/or titania or silica and/or zirconia and/or titania. In some embodiments, the catalysts further include a metal hydrogenation component. The metal hydrogenation component is typically a Group VI and/or a Group VIII metal. Preferably, the metal hydrogenation component can be a combination of a non-noble Group VIII metal with a Group VI metal. Suitable combinations can include Ni, Co, or Fe with Mo or W, preferably Ni with Mo or W. Effective conditions for catalytic dewaxing of a feedstock in the presence of a dewaxing catalyst can include a temperature of from 300° C. to 450° C., preferably 343° C. to 435° C., a hydrogen partial pressure of from 3.5 MPag to 34.6 MPag (500 psig to 5000 psig), preferably 4.8 MPag to 20.8 MPag, and a hydrogen circulation rate of from 178 m³/m³ (1000 SCF/B) to 1781 m³/m³ (10,000 scf/B), preferably 213 m³/m³ (1200 SCF/B) to 1068 m³/m³ (6000 SCF/B). The LHSV can be from about 0.2 h⁻¹ to about 10 h⁻¹, such as from about 0.5 h⁻¹ to about 5 h⁻¹ and/or from about 1 h⁻¹ to about 4 h⁻¹.

Solvent dewaxing typically involves mixing a feed with chilled dewaxing solvent to form an oil-solvent solution. Precipitated wax is thereafter separated by, for example, filtration. The temperature and solvent are selected so that the oil is dissolved by the chilled solvent while the wax is precipitated. An example of a suitable solvent dewaxing process involves the use of a cooling tower where solvent is prechilled and added incrementally at several points along the height of the cooling tower. The oil-solvent mixture is agitated during the chilling step to permit substantially instantaneous mixing of the prechilled solvent with the oil. The prechilled solvent is added incrementally along the length of the cooling tower so as to maintain an average chilling rate at or below 10° F. per minute, usually between about 1 to about 5° F. per minute. The final temperature of the oil-solvent/precipitated wax mixture in the cooling tower will usually be between 0 and 50° F. (−17.8 to 10° C.). The mixture may then be sent to a scraped surface chiller to separate precipitated wax from the mixture. Representative dewaxing solvents are aliphatic ketones having 3-6 carbon atoms such as methyl ethyl ketone and methyl isobutyl ketone, low molecular weight hydrocarbons such as propane and butane, and mixtures thereof. The solvents may be mixed with other solvents such as benzene, toluene or xylene. In general, the amount of solvent added will be sufficient to provide a liquid/solid weight ratio between the range of 5/1 and 20/1 at the dewaxing temperature and a solvent/oil volume ratio between 1.5/1 to 5/1. The solvent dewaxed oil is typically dewaxed to an intermediate pour point, preferably less than about +10° C., such as less than about 5° C. or less than about 0° C. The resulting solvent dewaxed oil is suitable for use in forming one or more types of Group I base stocks.

After exposing a feedstock to the dewaxing conditions, catalytic or solvent, and optionally a hydrotreating catalyst and/or a hydrofinishing catalyst, the resulting effluent can be separated and/or fractionated to form a plurality of products. Optionally, a first separation can be performed on the effluent to remove light ends and gas phase contaminants, such as H₂S and NH₃ generated during the conversion and hydrotreatment processes. The effluent can then be fractionated using one or more separation or fractionation stages to form at least one base stock product. The at least one least one base stock product can correspond to one or more base stock products having different viscosities. For example, the fractionation can be used to form one or more of a light neutral base stock product, a heavy neutral base stock product, and a brightstock base stock product.

### Properties of Base Stock

The viscosity-temperature relationship of a lubricating oil is one of the criteria which may be considered when selecting a lubricant for a particular application. Viscosity Index (VI) is an empirical, unitless number which indicates the rate of change in the viscosity of an oil within a given temperature range. Fluids exhibiting a relatively large change in viscosity with temperature are said to have a low viscosity index. A low VI oil, for example, will thin out at elevated temperatures faster than a high VI oil. Usually, the high VI oil is more desirable because it has higher viscosity at higher temperature, which translates into better or thicker lubrication film and better protection of the contacting machine elements. In embodiments, the base stocks of the present disclosure have a viscosity index (VI) of at least 80, such as a VI at a point in a range of 80-120. Alternatively, the base stocks of the present disclosure have a viscosity index in a range of 80-90, from 90-100, from 100-110, from 110-120, or any ranges therebetween. Viscosity index is determined according to ASTM method D 2270-93 [1998]. VI is related to kinematic viscosities measured at 40° C. and 100° C. using ASTM Method D 445-01.

As used herein, “kinematic viscosity at 100° C.” will be used interchangeably with “KV100” and “kinematic viscosity at 40° C.” will be used interchangeably with “KV40.” In embodiments, the base stock has a kinematic viscosity at 100° C. (KV100) at a point in a range of 13 cSt (centistokes) to about 16.5 cSt. Alternatively, the base stock has a kinematic viscosity at 100° C. of 13 cSt to 13.5 cSt, from 13.5 cSt to 14 cSt, from 14 cSt to 14.5 cSt, from 14.5 cSt to 15 cSt, from 15 cSt to 15.5 cSt, from 15.5 cSt to 16.5 cSt, or any ranges therebetween. In embodiments, the base stock has a kinematic viscosity at 40° C. (KV40) at a point in a range of 135 cSt (centistokes) to about 200 cSt. Alternatively, the base stock has a kinematic viscosity at 40° C. of 135 cSt to 140 cSt, from 140 cSt to 150 cSt, from 150 cSt to 160 cSt, from 160 cSt to 170 cSt, from 170 cSt to 180 cSt, from 180 cSt to 190 cSt, from 190 cSt to 200 cSt, or any ranges therebetween.

In embodiments, base stock of the present disclosure has a pour point at a point in a range of 0° C. to −25° C. Alternatively, a point in a range of from 0° C. to −10° C., at a point in a range of from −10° C. to −20° C., at a point in a range of from −20° C. to −25° C., or any ranges therebetween. The pour point is measured by ASTM B3983 or D5950-1.

The composition of the base stock is dependent upon the processing steps and severity of the processing steps involved in producing the base stock. In embodiments, the base stock is produced in a manner to minimize contaminants such as heteroatoms present in the base stock. In embodiments, the production of the base stock includes a deoxygenation and hydrotreating step to remove heteroatoms. In embodiments, the base stock contains less than 1 wt. % oxygen. Alternatively, the base stock includes less than 500 ppm (parts per million) oxygen. Alternatively, the base stock includes less than 400 ppm oxygen, less than 300 ppm oxygen, less than 200 ppm oxygen, less than 100 ppm oxygen, or less than 50 ppm oxygen. In embodiments, the base stock contains less than 0.1 wt. % sulfur. Alternatively, the base stock includes less than 50 ppm sulfur. Alternatively, the base stock includes less than 40 ppm sulfur, less than 30 ppm sulfur, less than 20 ppm sulfur, less than 10 ppm sulfur, or less than 5 ppm sulfur. In embodiments, the base stock contains less than 0.1 wt. % nitrogen. Alternatively, the base stock includes less than 50 ppm nitrogen. Alternatively, the base stock includes less than 40 ppm nitrogen, less than 30 ppm nitrogen, less than 20 ppm nitrogen, less than 10 ppm nitrogen, or less than 5 ppm nitrogen. Heteroatoms concentration can be measured by any suitable methods including those outlines in ASTM D8149-20, for example.

### Lubricant Compositions

If a lubricant base stock product is desired, the base stock product can be further fractionated to form a plurality of products. For example, lubricant base stock products can be made corresponding to a 2 cSt cut, a 4 cSt cut, a 6 cSt cut, and/or a cut having a viscosity higher than 6 cSt. For example, a lubricant base stock product fraction having a viscosity of at least 2 cSt can be a fraction suitable for use in low pour point application such as transformer oils, low temperature hydraulic oils, or automatic transmission fluid. A lubricant base stock product fraction having a viscosity of at least 4 cSt can be a fraction having a controlled volatility and low pour point, such that the fraction is suitable for engine oils made according to SAE J300 in 0 W- or 5 W- or 10 W-grades. This fractionation can be performed at the time the diesel (or other fuel) product from the second stage is separated from the lubricant base stock product, or the fractionation can occur at a later time. Any hydrofinishing and/or aromatic saturation can occur either before or after fractionation. After fractionation, a lubricant base stock product fraction can be combined with appropriate additives for use as an engine oil or in another lubrication service.

A base stock constitutes the major component of the engine or other mechanical component oil lubricant composition of the present disclosure and typically is present in an amount from about 50 to about 99 weight percent, preferably from about 70 to about 95 weight percent, and more preferably from about 85 to about 95 weight percent, based on the total weight of the composition. As described herein, additives constitute the minor component of the engine or other mechanical component oil lubricant composition of the present disclosure and typically are present in an amount ranging from about less than 50 weight percent, preferably less than about 30 weight percent, and more preferably less than about 15 weight percent, based on the total weight of the composition.

Mixtures of base stocks may be used if desired, for example, a base stock component and a co-base stock component. The co-base stock component is present in the lubricating oils of this disclosure in an amount from about 1 to about 99 weight percent, preferably from about 5 to about 95 weight percent, and more preferably from about 10 to about 90 weight percent, based on the total weight of the composition. The base stock blend can be present in the engine or other mechanical component oil lubricant composition from 15 wt. % to 99 wt. %, based on the total weight of the oil lubricant composition. Alternatively, from 15 wt. % to 30 wt. %, 30 wt. % to 60 wt. %, 60 wt. % to 80 wt. %, 80 wt. % to 90 wt. %, 90 wt. % to 95 wt. %, 95 wt. % to 99 wt. %, or any ranges therebetween.

In embodiments, the base stocks further include an additional base stock such as a group I, group II, group III, group IV, group V, or combinations thereof. In embodiments, the additional base stock is present in an amount of 1 wt. % to 99 wt. % by weight of the base stock. Alternatively, from 1 wt. % to 20 wt. %, 20 wt. % to 50 wt. %, 50 wt. % to 70 wt. %, 70 wt. % to 99 wt. %, or any ranges therebetween.

The formulated lubricating oil useful in the present disclosure may contain one or more of the other commonly used lubricating oil performance additives including but not limited to antiwear additives, detergents, dispersants, viscosity modifiers, corrosion inhibitors, rust inhibitors, metal deactivators, extreme pressure additives, anti-seizure agents, wax modifiers, other viscosity modifiers, fluid-loss additives, seal compatibility agents, lubricity agents, anti-staining agents, chromophoric agents, anti-foam agents, antioxidants, anti-rust additives, anti-wear additives, pour point depressant, demulsifiers, emulsifiers, densifiers, wetting agents, gelling agents, tackiness agents, colorants, and others. These additives are commonly delivered with varying amounts of diluent oil that may range from 5 weight percent up to greater than 90 weight percent.

The additives useful in this disclosure do not have to be soluble in the lubricating oils. Insoluble additives such as zinc stearate in oil can be dispersed in the lubricating oils of this disclosure.

When lubricating oil compositions contain one or more additives, the additive(s) are blended into the composition in an amount sufficient for it to perform its intended function. As stated above, additives are typically present in lubricating oil compositions as a minor component, typically in an amount of less than 50 weight percent, preferably less than about 30 weight percent, and more preferably less than about 15 weight percent, based on the total weight of the composition. Additives are most often added to lubricating oil compositions in an amount of at least 0.1 weight percent, preferably at least 1 weight percent, more preferably at least 5 weight percent.

The lube base stocks and lubricant compositions can be employed in the present disclosure in a variety of lubricant-related end uses, such as a lubricant oil or grease for a device or apparatus requiring lubrication of moving and/or interacting mechanical parts, components, or surfaces. Useful apparatuses include engines and machines. The lube base stocks of the present disclosure are suitable for use in the formulation of automotive crank case lubricants, automotive gear oils, transmission oils, many industrial lubricants including circulation lubricant, industrial gear lubricants, grease, compressor oil, pump oils, refrigeration lubricants, hydraulic lubricants and metal working fluids. Furthermore, the lube base stocks of this disclosure may be derived from renewable sources; such base stocks may qualify as sustainable product and can meet “sustainability” standards set by industry groups or government regulations. The lube base stocks and lubricant compositions can be useful to reduce wear between surfaces such as metal surfaces in internal combustion engines, electric motors, crankcases, gearboxes, transmissions, differentials, and other mechanical devices. The base stock or lubricant composition containing the base stock can form a film on the surfaces of mechanical devices to protect the surfaces from wear.

### Additional Embodiments

Accordingly, the present disclosure may base stocks produced using a liquid-liquid extraction process utilizing dihydrolevoglucosenone as a solvent, blends of the base stocks, formulated lubricant compositions containing the base stocks, and uses of the base stocks. The methods and systems may include any of the various features disclosed herein, including one or more of the following statements.

Statement 1. A method comprising: introducing a stream comprising a vacuum gas oil into a liquid-liquid extraction unit; contacting the vacuum gas oil with a dihydrolevoglucosenone solvent to extract a portion of aromatic compounds from the vacuum gas oil to produce a raffinate stream with reduced aromatic compound concentration; and dewaxing the raffinate stream to form a base stock.

Statement 2. The method of statement 1 wherein the vacuum gas oil has a T5 boiling point of at least about 371° C. and a T95 boiling point of about 538° C. or less.

Statement 3. The method of any of statements 1-2 wherein the dihydrolevoglucosenone solvent comprises dihydrolevoglucosenone and water wherein the water is present in an amount of 0.1 vol. % to 10 vol. % of the dihydrolevoglucosenone solvent.

Statement 4. The method of any of statements 1-3 wherein the dihydrolevoglucosenone solvent is introduced into the liquid-liquid extraction unit in an amount of about 100 vol. % to about 300 vol. % of the deasphalted oil.

Statement 5. The method of any of statements 1-4 wherein the dihydrolevoglucosenone solvent is introduced into the liquid-liquid extraction unit at a temperature at least about 10° C. to about 20° C. higher than the deasphalted oil.

Statement 6. The method of any of statements 1-5 wherein the base stock has a viscosity index in a range of about 80 to about 120 as measured by ASTM D2270-93.

Statement 7. The method of any of statements 1-6 wherein the base stock has a kinematic viscosity at 100° C. (KV100) at a point in a range of about 13 cSt to about 16.5 cSt as measured by ASTM D 445-01.

Statement 8. The method of any of statements 1-7 wherein the base stock has a kinematic viscosity at 40° C. (KV40) at a point in a range of about 135 cSt to about 200 cSt as measured by ASTM D 445-01.

Statement 9. The method of any of statements 1-8 wherein the dewaxing comprises solvent dewaxing and wherein the base stock is a Group I base stock.

Statement 10. The method of any of statements 1-9 wherein the dewaxing comprises catalytic dewaxing and wherein the base stock is a Group II or a Group III base stock.

Statement 11. A method comprising: thermally cracking a hydrocarbon feedstock to produce a cracked product stream; separating at least a portion of the cracked product stream to form a lubricant boiling range fraction of the cracked product stream; deasphalting at least a portion of the lubricant boiling range fraction to form a deasphalted oil; introducing the deasphalted oil into a liquid-liquid extraction unit; contacting the deasphalted oil with a dihydrolevoglucosenone solvent to extract a portion of aromatic compounds from the deasphalted oil to produce a raffinate stream with reduced aromatic compound concentration; and dewaxing the raffinate stream to form a base stock.

Statement 12. The method of statement 11 wherein thermally cracking the hydrocarbon feedstock comprises at least one process selected from the group consisting of fluidized coking, delayed coking, hydroconversion, and combinations thereof.

Statement 13. The method of any of statements 11-12 wherein the lubricant boiling range fraction has a 10% distillation boiling point of 343° C.-370° C.

Statement 14. The method of any of statements 11-13 wherein the liquid-liquid extraction unit comprises a counter-current liquid-liquid extractor.

Statement 15. The method of any of statements 11-14 wherein the dihydrolevoglucosenone solvent comprises dihydrolevoglucosenone and water wherein the water is present in an amount of 0.1 vol. % to 10 vol. % of the dihydrolevoglucosenone solvent.

Statement 16. The method of any of statements 11-15 wherein the dihydrolevoglucosenone solvent is introduced into the liquid-liquid extraction unit in an amount of about 100 vol. % to about 300 vol. % of the deasphalted oil.

Statement 17. The method of any of statements 11-16 wherein the dihydrolevoglucosenone solvent is introduced into the liquid-liquid extraction unit at a temperature at least about 10° C. to about 20° C. higher than the deasphalted oil.

Statement 18. The method of any of statements 11-17 wherein the dewaxing comprises solvent dewaxing and wherein the base stock is a Group I base stock.

Statement 19. The method of any of statements 11-18 wherein the dewaxing comprises catalytic dewaxing and wherein the base stock is a Group II or a Group III base stock.

Statement 20. The method of any of statements 11-19 wherein the base stock has a kinematic viscosity at 100° C. (KV100) at a point in a range of about 13 cSt to about 16.5 cSt as measured by ASTM D 445-01.

Statement 21. The method of any of statements 11-20 wherein the base stock has a kinematic viscosity at 40° C. (KV40) at a point in a range of about 135 cSt to about 200 cSt as measured by ASTM D 445-01.

Statement 22. The method of any of statements 11-21 wherein the base stock wherein the base stock has a viscosity index in a range of about 80 to about 120 as measured by ASTM D2270-93.

Statement 23. The method of any of statements 11-22 wherein the base stock has a pour point at a point in a range of 0° C. to −25° C. as measured by ASTM D97.

Statement 24. The method of any of statements 11-23 further comprising hydrotreating the raffinate stream prior to dewaxing the raffinate stream.

To facilitate a better understanding of the present invention, the following examples of certain aspects of some embodiments are given. In no way should the following examples be read to limit, or define, the entire scope of the disclosure.

### Example 1

In this example a heavy vacuum gas oil (HVGO) was subjected to liquid-liquid extraction LLE using two different extraction solvents, n-methyl pyrrolidone (NMP) and dihydrolevoglucosenone to produce a solvent extracted HVGO. The extraction solvent was mixed with water and the HVGO and extraction solvent were fed into the treater. The raffinate and extract refractive index were analyzed using a refractometer and the solvent content of each of the raffinate and extract was analyzed. An analysis on the HVGO was performed, the results thereof which are shown in Table 2. The LLE test conditions and results are shown in Table 3.

TABLE 2
HVGO Analysis

| Property | Test Method | Result |
|---|---|---|
| Refractive Index at 75° C. | Refractometer | 1.4940 |
| Density at 70° C., g/mL | ASTM D4052 | 0.8882 |
| Density at 15° C., g/mL | Calculated | 0.9251 |
| Kinematic Viscosity at 100° C., cSt | ASTM D445 | 16.53 |
| Total Aromatics, mmol/kg | Ultraviolet | 1000 |
| | Spectroscopy | |
| 2+ Rings Aromatics, mmol/kg | Ultraviolet | 743 |
| | Spectroscopy | |
| 3+ Rings Aromatics, mmol/kg | Ultraviolet | 435 |
| | Spectroscopy | |
| Aliphatic Sulfur, wt. % | Ultraviolet | 0.408 |
| | Spectroscopy | |
| Basic Nitrogen, ppm | Potentiometric | 371 |
| | Titration | |
| Micro Carbon Residue, wt. % | ASTM D4530 | 0.58 |

TABLE 3
LLE Test Conditions

| Extraction Solvent | NMP | dihydrolevoglucosenone |
|---|---|---|
| Water in Solvent, Vol. % | 1.5 | 1.5 |
| Feed Pump Speed | 60 | 60 |
| Solvent Pump Speed | 56 | 56 |
| Treat, Vol. % | 162.6 | 155.0 |
| Treater Bottom Temp, ° C. | 90 | 90 |
| Treater Top Temp, ° C. | 105 | 105 |
| Treater Delta T, deg C. | 15 | 15 |
| Raffinate Refractive Index at 75° C. | 1.4597 | 1.4671 |
| Raffinate Density at 15° C., g/mL (calculated) | 0.8755 | 0.8865 |
| Extract Refractive Index at 75° C. | 1.5341 | 1.5867 |
| Extract Density at 15° C., g/mL (calculated) | 0.9782 | 1.0550 |
| Solvent in Raffinate Solution Wt. % | 21.1 | 8.9 |
| Solvent in Extract Solution Wt. % | 84.9 | 94.3 |
| Raffinate Yield, Vol. % | 72.3 | 89.3 |

After extraction, the solvent extracted HVGO raffinate was dewaxed using methyl ethyl ketone (MEK) solvent at the conditions shown in Table 4 to produce a dewaxed oil. The dewaxed oil was analyzed for relevant physical properties, the results thereof which are shown in Table 5. It was observed that the dewaxed oil produced from dihydrolevoglucosenone extraction contained greater concentrations of aromatic species, higher viscosity, greater concentrations of total and aliphatic sulfur as well as basic nitrogen than the dewaxed oil produced from NMP extraction. The dihydrolevoglucosenone extraction produced dewaxed oil with lower saturates and viscosity index as well as lower amounts of solvent in the raffinate than the dewaxed oil produced from NMP extraction. The dihydrolevoglucosenone was observed to have higher raffinate yield.

TABLE 4
Dewaxing Conditions

| | NMP | dihydrolevoglucosenone |
|---|---|---|
| Filter Feed Temp, deg C. | −9 | −9 |
| Methyl Ethyl Ketone | 30 | 30 |
| Solvent, % | | |
| Solvent/Oil Dilution | 3:1 | 3:1 |

TABLE 5
Dewaxed Oil Analysis

| Property | Test Method | NMP | dihydrolevoglucosenone |
|---|---|---|---|
| Kinematic Viscosity at 100° C., cSt | ASTM D445 | 12.08 | 13.25 |
| Kinematic Viscosity at 40° C., cSt | ASTM D445 | 113.8 | 141.3 |
| Viscosity Index | ASTM D2270 | 95.0 | 85.7 |
| Total Aromatics, mmol/kg | Ultraviolet | 401 | 621 |
| | Spectroscopy | | |
| 2+ Rings Aromatics, mmol/kg | Ultraviolet | 115 | 284 |
| | Spectroscopy | | |
| 3+ Rings Aromatics, mmol/kg | Ultraviolet | 34.6 | 131 |
| | Spectroscopy | | |
| Pour Point, ° C. | ASTM D97 | −9 | −9 |
| Total Sulfur, wt. % | ASTM D4294 | 0.186 | 0.324 |
| Aliphatic Sulfur, wt. % | Ultraviolet | 0.07 | 0.12 |
| | Spectroscopy | | |
| Basic Nitrogen, ppm | Potentiometric | 82 | 186 |
| | Titration | | |
| Saturates, wt. % | ASTM D | 78.8 | 69.6 |
| | 2007 | | |

### Example 2

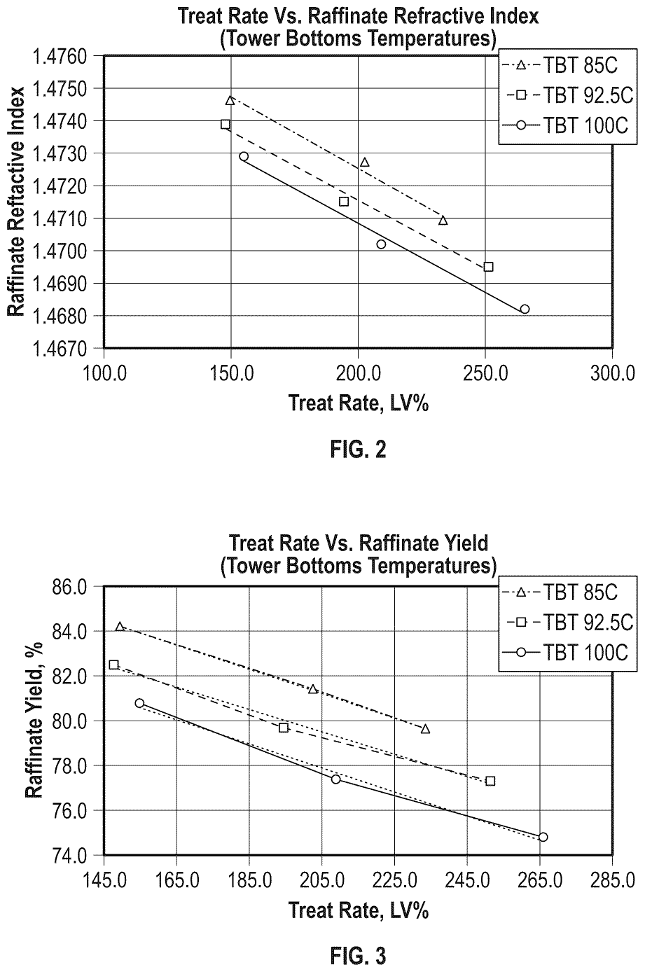

In this example, the solvent extraction of heavy vacuum gas oil with dihydrolevoglucosenone and NMP was repeated under varying process conditions such as treatment rates, temperatures, and treatment volume %. The resulting dewaxed oils were analyzed and compared. The results of the experiment are shown in graphical form in FIGS. 2-18.

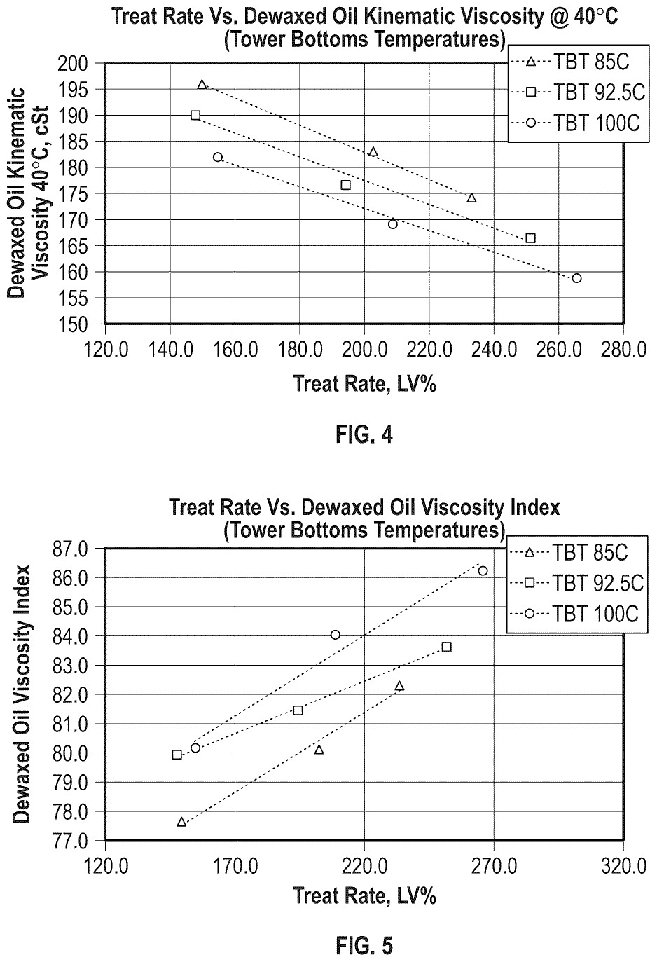

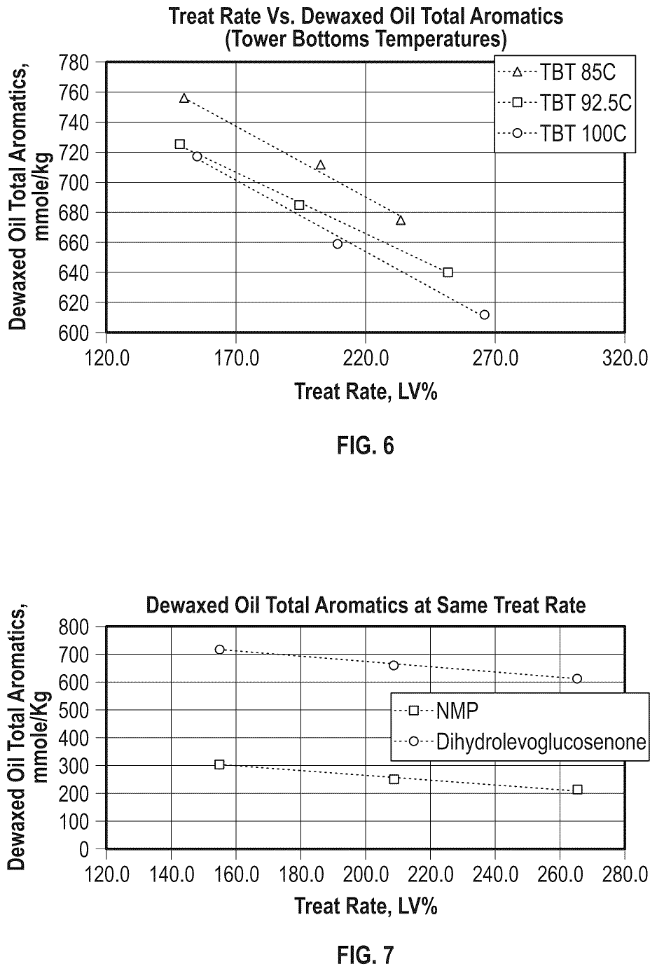

FIGS. 2-6 show data for dihydrolevoglucosenone at different treatment conditions. All of the dihydrolevoglucosenone data is lab experimental data whereas all NMP data is obtained from a modeling tool. FIG. 2 is a graph of experimental data of dihydrolevoglucosenone treatment rate versus raffinate refractive index. It was observed that raffinate refractive index decreased with increasing treater bottom temperature. FIG. 3 is a graph of experimental data of dihydrolevoglucosenone treatment rate versus raffinate yield. It was observed that raffinate yield decreased with increasing treater bottom temperature. FIG. 4 is a graph of experimental data of dihydrolevoglucosenone treatment rate versus dewaxed oil KV40. It was observed that KV40 viscosity decreased with increasing treater bottom temperature. FIG. 5 is a graph of experimental data of dihydrolevoglucosenone treatment rate versus dewaxed oil viscosity index. It was observed that dewaxed oil viscosity index increased with increasing treater bottom temperature. FIG. 6 is a graph of experimental data of dihydrolevoglucosenone treatment rate versus dewaxed oil total aromatics. It was observed that dewaxed oil total aromatics decreased with increasing treater bottom temperature. The data from FIGS. 2-6 indicate that dihydrolevoglucosenone is suitable as a lube feedstock extraction solvent.

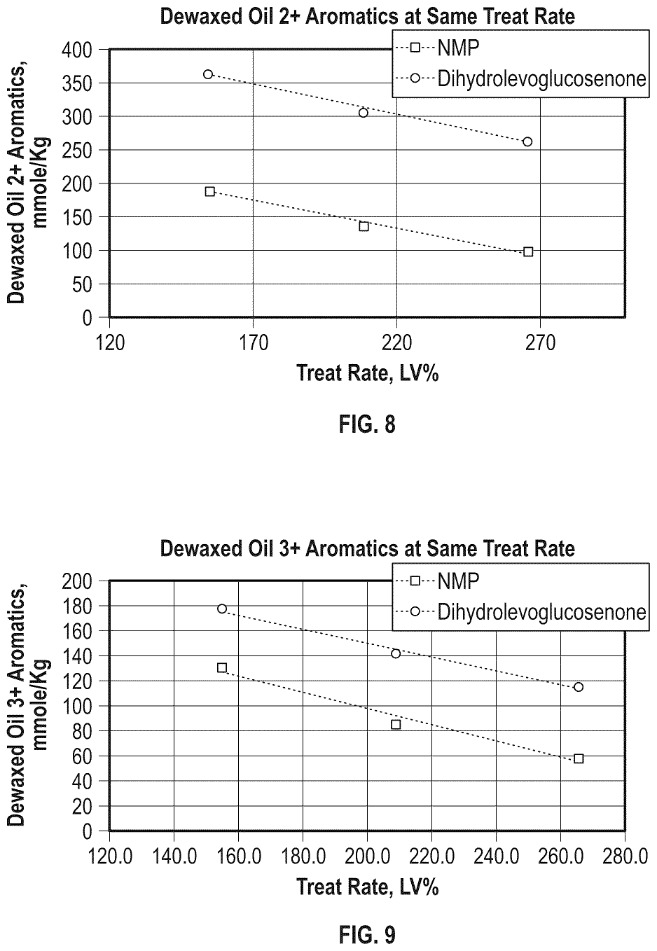

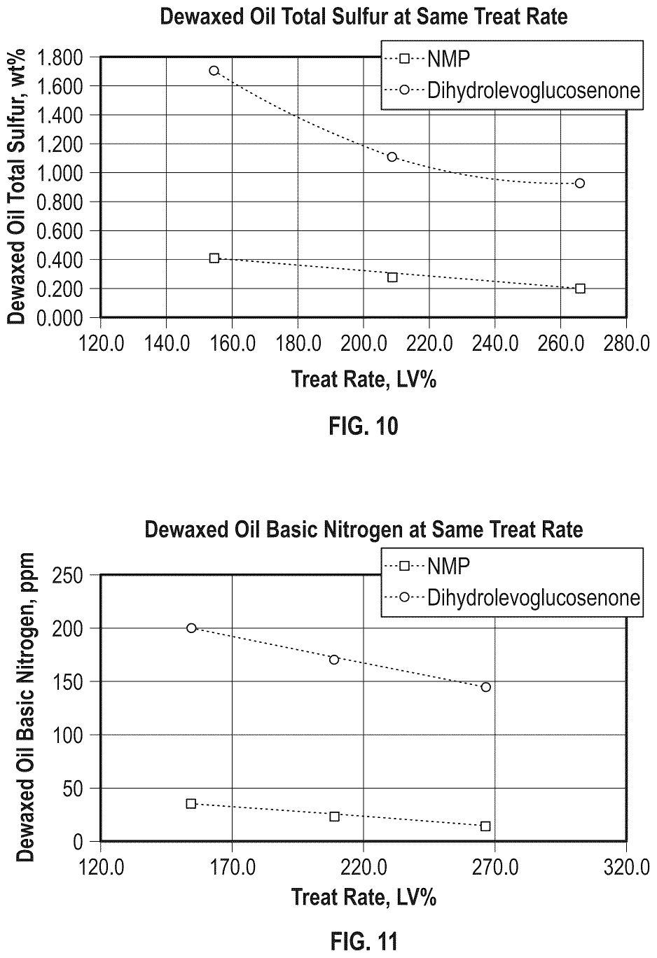

A comparative analysis of the performance of dihydrolevoglucosenone versus NMP is shown in FIGS. 7-18. FIG. 7 is a graph of experimental data of dewaxed oil total aromatics at constant treatment rate. FIG. 8 is a graph of experimental data of dewaxed oil total 2+ aromatics at constant treatment rate. FIG. 9 is a graph of experimental data of dewaxed oil total 3+ aromatics at constant treatment rate. FIG. 10 is a graph of experimental data of dewaxed oil sulfur content at constant treatment rate. FIG. 11 is a graph of experimental data of dewaxed oil basic nitrogen content at constant treatment rate in accordance with some embodiments of the present disclosure. The data is summarized in Table 6. It was observed that at the same extraction conditions of treatment rate that the dihydrolevoglucosenone retained more aromatics sulfur, and basic nitrogen in the dewaxed oil.

TABLE 6
Dihydrolevoglucosenone vs. NMP

| | | heavy | | | | | | |
|---|---|---|---|---|---|---|---|---|
| | | vacuum | | | | | | |
| | Test Method | gas oil | dihydrolevoglucosenone | | | NMP | | |
| Treat, % | | 0 | 154.8 | 208.9 | 265.7 | 154.8 | 208.9 | 265.7 |
| Total | Ultraviolet | 1000 | 718 | 659 | 612 | 308 | 250 | 215 |
| Aromatics, | Spectroscopy | | | | | | | |
| mmol/kg | | | | | | | | |
| 2 + Ring | Ultraviolet | 743 | 364 | 306 | 264 | 192 | 135 | 100 |
| Aromatics, | Spectroscopy | | | | | | | |
| mmol/kg | | | | | | | | |
| 3 + Ring | Ultraviolet | 435 | 178 | 142 | 116 | 131 | 86 | 58 |
| Aromatics, | Spectroscopy | | | | | | | |
| mmol/kg | | | | | | | | |
| Total Sulfur, | ASTM 4294 | 1.71 | 1.11 | 0.926 | 0.905 | 0.416 | 0.283 | 0.205 |
| wt. % | | | | | | | | |
| Aliphatic | Ultraviolet | 0.408 | 0.349 | 0.328 | 0.312 | 0.071 | 0.039 | 0.019 |
| Sulfur, wt. % | Spectroscopy | | | | | | | |
| Basic Nitrogen, | Potentiometric | 371 | 200 | 171 | 145 | 36 | 25 | 16 |
| ppm | Titration | | | | | | | |

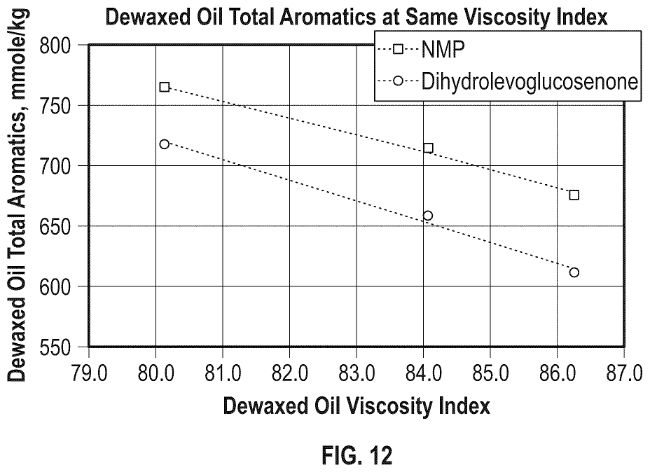

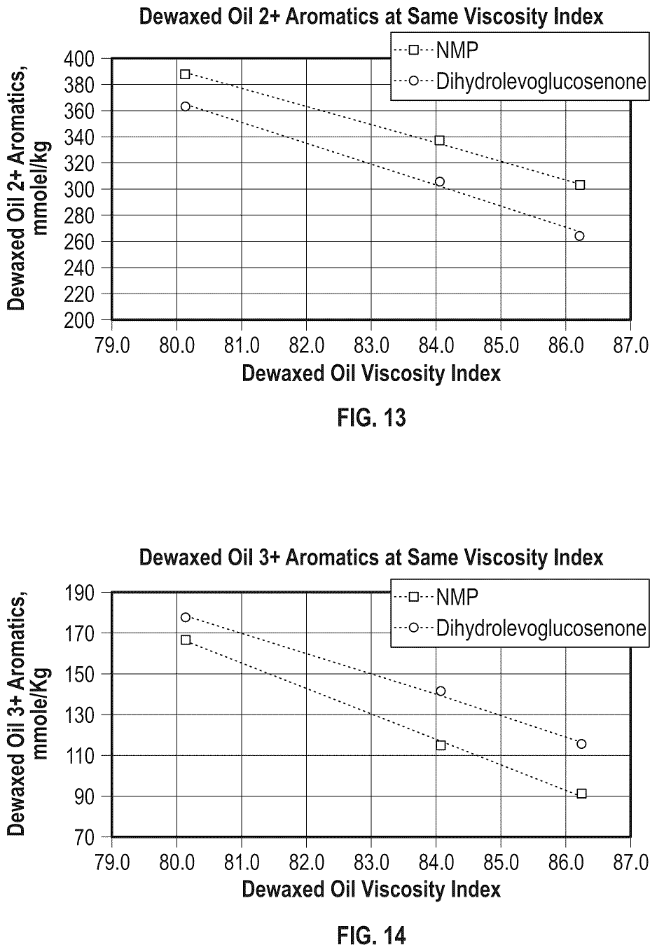

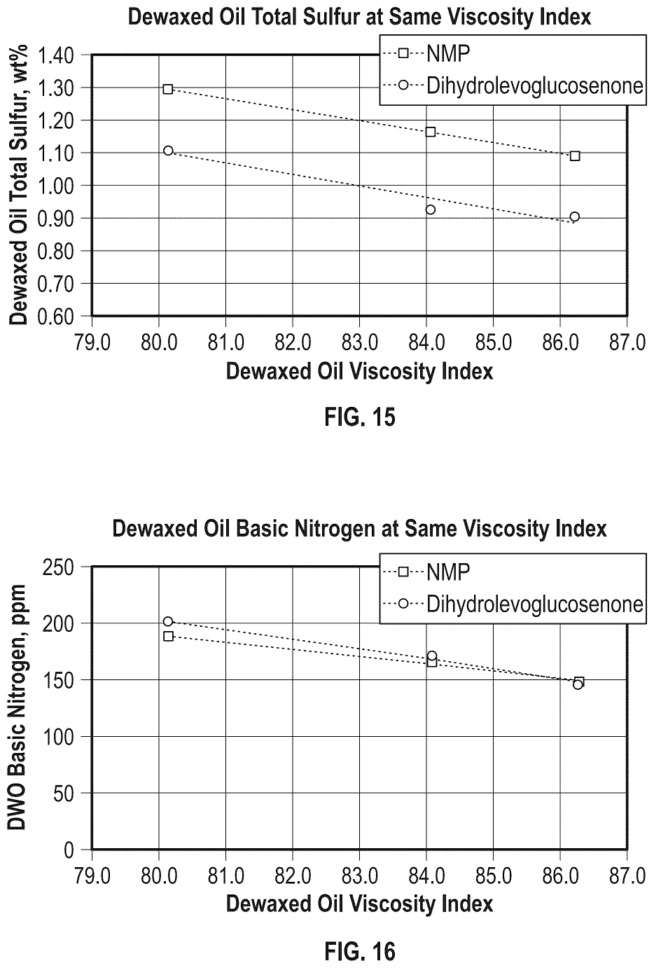

An analysis was performed of dewaxed oil at the same viscosity index. FIG. 12 is a graph of experimental data of dewaxed oil viscosity index versus total aromatics. FIG. 13 is a graph of experimental data of dewaxed oil viscosity index versus 2+ aromatics. FIG. 14 is a graph of experimental data of dewaxed oil viscosity index versus 3+ aromatics. FIG. 15 is a graph of experimental data of dewaxed oil viscosity index versus total sulfur. FIG. 16 is a graph of experimental data of dewaxed oil viscosity index versus total basic nitrogen. The data is summarized in Table 7. It was observed that at the same dewaxed oil viscosity index NMP retained slightly more total and 2+ aromatics, whereas dihydrolevoglucosenone retained slightly more 3+ aromatics. It was further observed that higher sulfur is retained in the dewaxed oil with NMP versus dihydrolevoglucosenone and there is similar basic nitrogen retention for NMP and dihydrolevoglucosenone.

TABLE 7
Dihydrolevoglucosenone vs. NMP

| | Test Method | dihydrolevoglucosenone | | | NMP | | |
|---|---|---|---|---|---|---|---|
| Total Aromatics, | Ultraviolet | 718 | 659 | 612 | 765 | 715 | 676 |
| mmol/kg | Spectroscopy | | | | | | |
| 2 + Rings Aromatics, | Ultraviolet | 364 | 306 | 264 | 389 | 338 | 303 |
| mmol/kg | Spectroscopy | | | | | | |
| 3 + Rings Aromatics, | Ultraviolet | 178 | 142 | 116 | 167 | 115 | 91 |
| mmol/kg | Spectroscopy | | | | | | |
| Total Sulfur, wt. % | ASTM | 1.11 | 0.926 | 0.905 | 1.3 | 1.17 | 1.09 |
| | D4294 | | | | | | |
| Aliphatic Sulfur, wt. % | Ultraviolet | 0.349 | 0.328 | 0.312 | 0.418 | 0.407 | 0.393 |
| | Spectroscopy | | | | | | |
| Basic Nitrogen, ppm | Potentiometric | 200 | 171 | 145 | 187 | 165 | 147 |
| | Titration | | | | | | |
| Viscosity Index | ASTM | 80.1 | 84.1 | 86.2 | 80.1 | 84.1 | 86.2 |
| | D2270 | | | | | | |

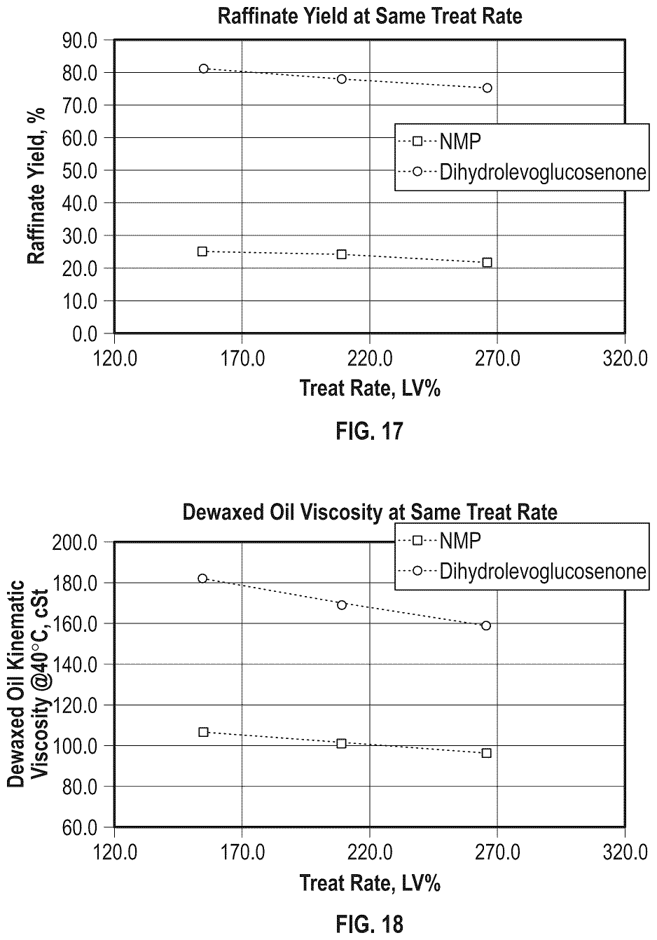

An analysis was performed for raffinate yield and KV 40 versus treatment rate. FIG. 17 is a graph of experimental data of dewaxed oil (DWO) treatment rate versus raffinate yield for NMP and dihydrolevoglucosenone and FIG. 18 is a graph of experimental data of dewaxed oil treatment rate versus KV40 for NMP and dihydrolevoglucosenone. The data is summarized in Table 8. It was observed that dihydrolevoglucosenone provides higher raffinate yields and dewaxed oil viscosity at the same extraction conditions of treatment rate compared to NMP.

TABLE 8
Dihydrolevoglucosenone vs. NMP

| | Test | | | | | | |
|---|---|---|---|---|---|---|---|
| | Method | dihydrolevoglucosenone | | | NMP | | |
| Treat, % | | 154.8 | 208.9 | 265.7 | 154.8 | 208.9 | 265.7 |
| Raffinate Yield, % | | 80.8 | 77.4 | 74.8 | 25.3 | 24.4 | 22.1 |
| Dewaxed Oil Kinematic | ASTM | 15.18 | 14.78 | 14.36 | 12.15 | 11.84 | 11.56 |
| Viscosity at 100° C., cSt | D445 | | | | | | |
| Dewaxed Oil Kinematic | ASTM | 182.2 | 169.2 | 159 | 106.9 | 101.3 | 96.45 |
| Viscosity at 40° C., cSt | D445 | | | | | | |

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

All numerical values within the detailed description and the claims herein are modified by “about” or “approximately” the indicated value, and take into account experimental error and variations that would be known to a person of ordinary skill in the art.

While compositions, methods, and processes are described herein in terms of“comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

What is claimed is:

1. A method comprising:
introducing a stream comprising a vacuum gas oil into a liquid-liquid extraction unit;
contacting the vacuum gas oil with a dihydrolevoglucosenone solvent to extract a portion of aromatic compounds from the vacuum gas oil to produce a raffinate stream with reduced aromatic compound concentration; and
dewaxing the raffinate stream to form a base stock.

2. The method of claim 1 wherein the vacuum gas oil has a T5 boiling point of at least about 371° C. and a T95 boiling point of about 538° C. or less.

3. The method of claim 1 wherein the dihydrolevoglucosenone solvent comprises dihydrolevoglucosenone and water wherein the water is present in an amount of 0.1 vol. % to 10 vol. % of the dihydrolevoglucosenone solvent.

4. The method of claim 1 wherein the dihydrolevoglucosenone solvent is introduced into the liquid-liquid extraction unit in an amount of about 100 vol. % to about 300 vol. % of the deasphalted oil.

5. The method of claim 1 wherein the dihydrolevoglucosenone solvent is introduced into the liquid-liquid extraction unit at a temperature at least about 10° C. to about 20° C. higher than the deasphalted oil.

6. The method of claim 1 wherein the base stock has a viscosity index in a range of about 80 to about 120 as measured by ASTM D2270-93.

7. The method of claim 1 wherein the base stock has a kinematic viscosity at 100° C. (KV100) at a point in a range of about 13 cSt to about 16.5 cSt as measured by ASTM D 445-01 and wherein the base stock has a kinematic viscosity at 40° C. (KV40) at a point in a range of about 135 cSt to about 200 cSt as measured by ASTM 445-01.

8. (canceled)

9. The method of claim 1 wherein the dewaxing comprises solvent dewaxing and wherein the base stock is a Group I base stock.

10. The method of claim 1 wherein the dewaxing comprises catalytic dewaxing and wherein the base stock is a Group II or a Group III base stock.

11. A method comprising:
thermally cracking a hydrocarbon feedstock to produce a cracked product stream;
separating at least a portion of the cracked product stream to form a lubricant boiling range fraction of the cracked product stream;
deasphalting at least a portion of the lubricant boiling range fraction to form a deasphalted oil;
introducing the deasphalted oil into a liquid-liquid extraction unit;
contacting the deasphalted oil with a dihydrolevoglucosenone solvent to extract a portion of aromatic compounds from the deasphalted oil to produce a raffinate stream with reduced aromatic compound concentration; and
dewaxing the raffinate stream to form a base stock.

12. The method of claim 11 wherein thermally cracking the hydrocarbon feedstock comprises at least one process selected from the group consisting of fluidized coking, delayed coking, hydroconversion, and combinations thereof.

13. The method of claim 11 wherein the lubricant boiling range fraction has a 10% distillation boiling point of 343° C.-370° C.

14. The method of claim 11 wherein the liquid-liquid extraction unit comprises a counter-current liquid-liquid extractor.

15. The method of claim 11 wherein the dihydrolevoglucosenone solvent comprises dihydrolevoglucosenone and water wherein the water is present in an amount of 0.1 vol. % to 10 vol. % of the dihydrolevoglucosenone solvent.

16. The method claim 11 wherein the dihydrolevoglucosenone solvent is introduced into the liquid-liquid extraction unit in an amount of about 100 vol. % to about 300 vol. % of the deasphalted oil.

17. The method of claim 11 wherein the dihydrolevoglucosenone solvent is introduced into the liquid-liquid extraction unit at a temperature at least about 10° C. to about 20° C. higher than the deasphalted oil.

18. The method of claim 11 wherein the dewaxing comprises solvent dewaxing and wherein the base stock is a Group I base stock or wherein the dewaxing comprises catalytic dewaxing and wherein the base stock is a Group II or a Group III base stock.

19. (canceled)

20. The method of claim 11 wherein the base stock has a kinematic viscosity at 100° C. (KV100) at a point in a range of about 13 cSt to about 16.5 cSt as measured by ASTM D 445-01, a kinematic viscosity at 40° C. (KV40) at a point in a range of about 135 cSt to about 200 cSt as measured by ASTM D 445-01, and wherein the base stock has a viscosity index in a range of about 80 to about 120 as measured by ASTM D2270-03.

21.-22. (canceled)

23. The method of claim 11 wherein the base stock has a pour point at a point in a range of 0° C. to −25° C. as measured by ASTM D97.

24. The method of claim 11 further comprising hydrotreating the raffinate stream prior to dewaxing the raffinate stream.
